(19) United States
(12) Patent Application Publication
(10) Pub. No.: US 2005/0002585 A1
(43) Pub. Date: Jan. 6, 2005

(54) Privacy filter

(76) Inventors: Michael Brauckmann, Witten (DE); Martin Clasen, Bochum (DE); Stefan Gehlen, Bochum (DE); Christoph von der Malsburg, Bochum (DE); Martin Werner, Hemer (DE)

Correspondence Address: IP Strategies, Suite 1, 21/2 Wall Street, Ashville, NC, 28801, US

(21) Appl. No.: 10/480,371

(22) PCT Filed: Jun. 4, 2002
(86) PCT No.: PCT/EP02/06135

(30) Foreign Application Priority Data
Jun. 15, 2001 (EP) 01114472.2

(51) Int. Cl. G06K 9/40; G06K 9/36

(52) U.S. Cl. 382/254; 382/232; 382/276

(57) ABSTRACT

The invention relates to a method for reversibly rendering at least one object in an image unrecognizable, whereby each object to be rendered unrecognizable is automatically detected in an original image and at least one data set is generated comprising image information for the representation of the image in which each object to be rendered unrecognizable is, in fact, rendered unrecognizable, and additional information that permits the restoration of each object that has been rendered unrecognizable in the image.

### FIELD OF THE INVENTION

The invention relates to an automatic method for reversibly rendering objects in static and moving images unrecognizable, especially of people and faces, and a method for the restoration of selected objects that have been rendered unrecognizable.

### STATE OF THE ART

Faces or other objects in images, e.g. car index numbers, are generally rendered unrecognizable for reasons of data protection, which is therefore usually required on a mandatory basis. Conventional methods for rendering objects unrecognizable, however, are often very time-consuming and in many cases require an operator because of the manual control interventions required.

For static images, there is a method for making faces unrecognizable in which the faces are automatically recognized and coloured black. The method is irreversible, since the original information is deleted. A reconstruction of the faces (or selected faces) is thus neither proposed nor possible with this method.

An example of the above-mentioned method is the automatic rendering unrecognizable of the faces of passengers on images that are taken in speed traps. To protect privacy, the originals are read in using a reader device (e.g. a scanner) and then destroyed. In the images that have been read in, the faces of passengers are rendered unrecognizable by being blacked out, whereby the image information of the corresponding image areas is irreversibly destroyed.

With moving images (e.g. video images), various methods are known which are related to the recognition of objects or the rendering unrecognizable of images or objects in images.

The image content is rendered completely unrecognizable, for example, in so-called pay TV programmes in which the transmitted video signal is encrypted with a particular code. The method is reversible, whereby the original image content can be recovered by receiver devices that are fitted with a corresponding decryption device.

To protect the privacy of people, there are in addition semi-automatic methods of rendering the faces of the persons concerned unrecognizable in video images. In this method, initially (i.e. at the start of the video sequence), the facial areas are marked manually by an operator, following which a detection device determines the associated markings or object edges. These edges are used in the subsequent images to automatically follow the corresponding image area, whereby the operator must carry out corrections if necessary. With this method, rendering the object unrecognizable is also irreversible, i.e. subsequent restoration is not proposed.

There is at the moment no method which is applicable to both static and moving images and capable of automatically recognizing objects on the images and rendering the corresponding image content unrecognizable through encryption.

In particular, there is at the moment no method which allows authorized users to subsequently restore (partially or wholly) the image content that has been rendered unrecognizable from the images processed using traditional methods.

### DESCRIPTION OF THE INVENTION

Consequently, it is an object of the invention to provide a reversible method in the processing of images for automatically detecting objects in static or moving images and rendering the corresponding image content unrecognizable through encryption.

This object is solved by the method described in Claim 1.

According to this, the invention provides a method for reversibly rendering at least one object in an image unrecognizable comprising the following steps: automatically detecting any object to be rendered unrecognizable in an original image, generating at least one data set comprising both the image information for the representation of the image in which each object to be rendered unrecognizable is rendered unrecognizable and also the additional information to be able to restore each object rendered unrecognizable in the image.

Without special authorization, only the data set is available or only the part of the data set may be used which is needed to represent the image that has been rendered partially unrecognizable. The image may be, for example, a scene recorded by a surveillance camera in which, for reasons of data protection, the face of a particular person or all persons must be rendered unrecognizable.

Restoring the face of a selected person or all persons e.g. for the purposes of criminal prosecution, is only possible if the additional information is also available, whether the data set comprising the additional information is provided or the additional information concealed in the data set is made usable.

Objects (faces) in images are automatically recognized preferably using methods known in technology which are based on the use of neuronal networks or other statistical methods or on the use of models in the form of elastic graphs.

In a preferred further development of the method according to the invention as described above, from the original data precisely one data set is generated comprising the image information and additional information.

This allows simple storage of the processed image data and, in the case of a necessary restoration, the unproblematic assignment of image and additional information. In addition, this further development also allows the image to be transmitted by traditional means. The additional information corresponds to a part of the data set, but is concealed within the entire data set in such a way that the additional information normally cannot be detected and used as such.

Methods of this type according to which information can be concealed in visible images are sufficiently described in technology and do not need any further explanation here.

If higher security standards are necessary, an alternative further development of the method according to the invention is preferred, according to which at least two data sets are generated, whereby a first data set comprises the image information and a second data set comprises the additional information.

Here, only the first data set is available to unauthorized persons, whilst access to the second data set, which may be stored and/or transmitted separately, is only possible with special authorization. Without this second data set, it is basically impossible to restore the image content that has been rendered unrecognizable. Graphically, the image that has been rendered partially unrecognizable through this further development corresponds to an image from which the areas rendered unrecognizable have been cut out, whereby the cut out parts are kept with the associated local information which is necessary for possible restoration in a separate location protected from access.

In a particularly preferred further development of the method, every object to be rendered unrecognizable in an image is rendered unrecognizable with the same code.

The code is the specification according to which an image area is rendered unrecognizable and its reverse, i.e. the specification applied to the image and additional information according to which the image rendered unrecognizable is restorable. The code may be a part of the data set also containing the additional information, but may also be stored in a separate place.

If a uniform code is used to render a partial area or several areas in an image unrecognizable, both the encryption (rendering unrecognizable) and the decryption (restoration) may be carried out with devices which—compared with simple image processing without encryption—only make comparatively moderately increased demands on computer, memory and transmission capacities.

If more stringent demands are made on the protection of privacy, an alternative and slightly more complex further development of the method according to the invention is available under which at least two objects are rendered unrecognizable with different codes, or, in extreme cases, each object with a different code.

This means that it is possible to restore selected objects in an image selectively, whilst other objects remain unrecognizable in the partially restored image.

A further development under which each object of a previously determined object class is automatically detected and rendered unrecognizable is particularly preferred.

If, for example, in a criminal prosecution, a person with particular personal characteristics (hair colour, gender, skin colour, etc.) is being sought, an image taken by a surveillance camera may be encrypted using suitably selected codes and then partially decrypted again, whereby the privacy of all those persons who do not have the named characteristics is protected.

A further object of the invention is the provision of a reverse method which allows authorized users to partially or completely restore the image content rendered unrecognizable with the encryption methods according to the invention.

This object is solved by the method described in Claim 7.

This method comprises the steps: evaluating the additional information in order to generate a restored partial image information corresponding to at least one object rendered unrecognizable, and replacing a corresponding area of the image information by the restored partial image information.

A method with which individually selectable objects may be restored in an image with several objects rendered unrecognizable is particularly preferred.

This allows a selective restoration of particular objects, whilst other objects also remain unrecognizable in the partially restored image.

Alternatively, the method may be designed in such a way that all objects rendered unrecognizable are restorable with at least one specified common characteristic or that all objects rendered unrecognizable are restorable.

In the following, the invention is described in detail using sample embodiments preferred in particular for video images.

The unencrypted images are described in the following as originals or original images, whilst images in which at least a partial area has been rendered unrecognizable are described as encrypted images. Accordingly, the images resulting from the restoration of the partial areas that have been rendered unrecognizable are described as restored images.

The method according to the invention generates, from the originals, processed images which have partial areas that have been rendered unrecognizable by encryption. The corresponding data are stored and/or transmitted as processed image data. The term “normal reproduction” is used for a reproduction in which the processed images show partial areas rendered unrecognizable in an otherwise normal image.

The method according to the invention does not destroy the original information content of the areas rendered unrecognizable, but merely encrypts it, whereby various preferred types of encryption are described in the following.

The image data may exist either in analog or in digital form.

The preferred embodiments of the method according to the invention can be divided into two different categories depending on purpose:
a) “Ciphering”: here, from the original image, a single data set is generated which contains both the copy with the area(s) that has (have) been rendered unrecognizable and also the information necessary to restore the image content, although the latter is in a form that cannot be used without knowledge of the encryption specification.
b) “Cutting out”: here, from the original image, at least two data sets are generated, one of which represents the copy including the areas rendered unrecognizable, whilst at least one second data set contains the image information missing in the copy and the information necessary to restore the original.
   Ciphering

In a first preferred embodiment, the method is designed in such a way that it generates, from the original image, a single data set, which comprises both the copy with the area(s) rendered unrecognizable and also the information necessary to restore the image content(s) rendered unrecognizable.

This information (code) does not comprise any image contents here, but merely represents a specification that is necessary to be able to restore the image content that has been rendered unrecognizable.

A regionally delimited image content may be rendered unrecognizable, i.e. encrypted by the fact that in the corresponding image areas whole lines or line sections are scrambled or interchanged. Methods of this type are known, for example, from the encryption of TV programmes, but are applied to the entire image content there. The code required to restore a partial area rendered unrecognizable comprises information about the nature of the encryption and the position of the encrypted area.

The latter may change from image to image, since the area rendered unrecognizable generally represents a moving object, the image position of which can change in a sequence of images.

The key may be stored or transmitted or reproduced discreetly together with the information representing the copy in an image edge surrounding the copy or in partial areas of the image edge.

In an embodiment that is particularly preferred for traditional image transmission, the code is transmitted in the lines that are not visible on a screen at the beginning of the image, which is also used, for example, for video text transmission.

Various methods of encryption exist specially for digital data which allow the information necessary for restoration to be stored or transmitted within a single data set (i.e. together with the copy) protected against unauthorized reading.

Cutting Out

In a second preferred embodiment, the method is designed in such a way that it generates at least two separate data sets from the original image: the first one for the copy with the areas rendered unrecognizable, and at least one additional one which comprises the image data of areas rendered unrecognizable in the copy (additional information) and the information (code) required to restore the original. In graphic terms, this method corresponds to cutting out, from the original, image information to be rendered unrecognizable and storing the cut out parts in a concealed location.

The separate data sets are stored separately and may be transmitted via separate channels, whereby a “normal” reproduction only uses the first data set.

A distinction should be made between two cases, depending on purpose:
i) Handling the image data (i.e. any type of image processing such as encryption/storage/transmission/reproduction) without information loss through data compression, and
ii) Handling the image data taking information loss through data compression into account.

The first case (i) may be applied for both analog and digital data equally: the image content rendered unrecognizable is transmitted as a coded or uncoded data set via a separate channel or stored in a separate storage location. Without this data set, it is impossible to restore the image content that has been rendered unrecognizable. The code is used for the correct assignment of image and additional information. In addition, the code may be used for coding and decoding of the image data held in the additional information.

The second case (ii) may be applied advantageously with digital image data in particular, since, in this field, many methods of data compression involving losses are in use.

The digital decoding method is to be designed so that it is not sensitive to the changes arising as a result of compression. Changes of this type may also be perceived as faults/errors, so that error-correcting methods (known as error correction codes) may preferably be applied which are used, for example, in the error correction of CDs.

Similar methods are also used to compensate for channel interference in the satellite transmission of images.

These error correction codes should be preceded by the method to render the image content unrecognizable since the error correction codes are not used for access protection, but are merely intended to ensure transmission that is as unsusceptible to errors as possible.

1. A method for reversibly rendering at least one object in an image unrecognizable, comprising the steps of:
automatically detecting any object to be rendered unrecognizable in an original image,
generating at least one data set comprising:
image information for representation of the image in which each object to be rendered unrecognizable is in fact rendered unrecognizable,
additional information to be able to restore each object rendered unrecognizable in the image.

2. A method according to claim 1 in which a data set is generated comprising the image information and the additional information.

3. A method according to claim 1 in which at least two data sets are generated, whereby a first data set comprises the image information and a second data set comprises the additional information.

4. A method according to claim 1 in which each object is rendered unrecognizable with the same code.

5. A method according to claim 1 in which at least two objects are rendered unrecognizable with different codes.

6. A method according to claim 1 in which each object of a previously determined object class is automatically detected and rendered unrecognizable.

7. A method to restore at least one object rendered unrecognizable in an image according to a method according to claim 1, comprising the steps of:
evaluating the additional information in order to generate a restored partial image information corresponding to the at least one object rendered unrecognizable,
replacing a corresponding area of the image information by the restored partial image information.

8. A method according to claim 7 with which, in an image with several objects rendered unrecognizable, individually selectable objects are restorable.

9. A method according to claim 7 with which all objects rendered unrecognizable are restored with at least one specified common characteristic.

10. A method according to claim 7 with which all objects rendered unrecognizable are restored.

11. A method according to claim 2 in which each object is rendered unrecognizable with the same code.

12. A method according to claim 3 in which each object is rendered unrecognizable with the same code.

13. A method according to claim 2 in which at least two objects are rendered unrecognizable with different codes.

14. A method according to claim 3 in which at least two objects are rendered unrecognizable with different codes.

15. A method according to claim 4 in which each object of a previously determined object class is automatically detected and rendered unrecognizable.

16. A method according to claim 5 in which each object of a previously determined object class is automatically detected and rendered unrecognizable.

17. A method to restore at least one object rendered unrecognizable in an image according to a method according to claim 2, comprising the steps of:
evaluating the additional information in order to generate a restored partial image information corresponding to the at least one object rendered unrecognizable,
replacing a corresponding area of the image information by the restored partial image information.

18. A method to restore at least one object rendered unrecognizable in an image according to a method according to claim 3, comprising the steps of:
evaluating the additional information in order to generate a restored partial image information corresponding to the at least one object rendered unrecognizable,
replacing a corresponding area of the image information by the restored partial image information.

19. A method to restore at least one object rendered unrecognizable in an image according to a method according to claim 6, comprising the steps of:
evaluating the additional information in order to generate a restored partial image information corresponding to the at least one object rendered unrecognizable,
replacing a corresponding area of the image information by the restored partial image information.

20. A method according to claim 8 with which all objects rendered unrecognizable are restored with at least one specified common characteristic.
